(19) United States
(12) Patent Application Publication
(10) Pub. No.: US 2002/0095226 A1
(43) Pub. Date: Jul. 18, 2002

(54) Electronic apparatus

(76) Inventors: Kenji Suzuki, Chiba-shi (JP); Masao Kasuga, Chiba-shi (JP); Akihiro Iino, Chiba-shi (JP)

Correspondence Address: ADAMS & WILKS, 31st Floor, 50 Broadway, New York, NY, 10004, US

(21) Appl. No.: 09/941,024

(22) Filed: Aug. 28, 2001

(30) Foreign Application Priority Data
Aug. 29, 2000 (JP) 2000-258986

(51) Int. Cl. G05B 19/18

(52) U.S. Cl. 700/56

(57) ABSTRACT

An electronic apparatus is offered which has a function of detecting the position of a driven member with high reliability while achieving power saving. The apparatus comprises an electric motor an object that is a member driven by the motor, a gear reducer for transmitting the power of the motor to the object, an optical sensor for detecting the rotational position of the gear reducer and indirectly detecting the rotational position of the object, and an optical sensor control circuit for varying the state of drive of the optical sensor according to the circumstance of operation of the object, i.e., the rotational speed of the motor. The optical sensor is intermittently driven by the optical sensor control circuit. The frequency of the intermittent drive and the duty ratio are varied according to the rotational speed of the motor.

### BACKGROUND OF THE INVENTION

1. Field of the Invention

The present invention relates to an electronic apparatus and, more particularly, to an electronic apparatus equipped with a function of detecting the position of a driven member reliably and with low power consumption.

2. Description of the Related Art

Some known electronic apparatus detect information about the position of a member driven by an electronic motor by a photo interrupter and control the position of the driven member to place it in position. The related art electronic apparatus is described by referring to FIGS. 16 and 17, which are a vertical cross section and a plan view, respectively, of the electronic apparatus using the related art photo interrupter to detect the position of a driven member. This electronic apparatus, indicated by 500, is an electronic timepiece using electronic motors for driving timepiece hands that are driven members. Rotation of the first motor M1 is transmitted to a minute wheel 6 via a first gear train G1. Rotation of the second motor M2 is transmitted to an hour hand wheel 508 via a second gear train G2. The apparatus has a first detection unit Dl and a second detection unit D2 for detecting reference positions of the minute hand wheel 506 and the hour hand wheel 508, respectively.

The first detection unit Dl consists of a minute detection sensor 511 mounted on a circuit board 505, an opening portion 572C formed in the second wheel 572 of the first gear train, and a reflective portion 506C formed on the minute hand wheel 506. The reflective portion 506C registers with the opening portion 572C only once in one revolution.

The second detection unit D2 comprises an hour detection sensor 521 mounted on the circuit board, a second hour hand wheel 522 rotating in phase with the hour hand wheel 508, and a reflective portion 522C formed on the second wheel 592 of the second gear train. The reflective portion 522C registers with an opening portion 592C only once in one revolution.

To compensate deviations of the hour and minute hands based on time information carried by radio waves or the like, information about the positions of the hour and minute hands that are driven members is detected by reflection type photo interrupters, and the positions of the hour and minute hands are controlled (see Japanese patent laid-open No. 148354/1994). Generally, the photo interrupters are constantly driven to detect the positions of the hour and minute hands.

In the related art electronic apparatus, however, if the photo interrupters are used to detect the positions, a large amount of electric power is necessary to detect the positions, although accurate detection of the positions is possible. This requirement is not limited to optical sensors such as photo interrupters. Magnetic detection unit such as magnetoresistive devices and Hall devices must also satisfy a similar requirement. Especially, in small-sized electronic devices on which only a small-sized, small-capacity battery must be installed due to their dimensional constraints, the aforementioned requirement is a great issue. Hence, there is a demand for a technique for saving electric power consumption without deteriorating the detection accuracy.

### SUMMARY OF THE INVENTION

Accordingly, it is an object of the present invention to provide an electronic apparatus equipped with a function of detecting the position of a driven member reliably and with lower electric power consumption.

The present invention provides an electronic apparatus having a power source for driving the electronic apparatus, a driven member driven by the driver source, and a detection unit for detecting the position of the driven member, the electronic apparatus being characterized in that it further includes a detection unit control circuit for varying the state of drive of the detection unit according to circumstances of operation of the driven member.

With this apparatus, the detection unit is driven by the detection unit control circuit according to the circumstances of operation of the driven member. Therefore, the detection unit can be driven optimally in terms of electric power without sacrificing the detection accuracy of the detection unit.

The present invention also provides an electronic apparatus having an external corrective unit for correcting the position of the aforementioned driven member by an external operation and an external operation detection unit for detecting the state of operation of the external corrective unit. The detection unit control circuit recognizes circumstances of operation of the driven member based on information obtained from the external operation detection unit and varies the state of drive of the detection unit.

Since the state of drive of the detection unit can be varied as described above, the apparatus can cope with an external operation for correction, or circumstances of operation, that is greatly different from normal operation of the driven member. Therefore, a more sophisticated function can be imparted to the electronic apparatus while maintaining the reliability. The external operation may be an operation performed by a person.

The present invention also provides an electronic apparatus having a voltage detection circuit for detecting the voltage level of a power supply. The above-described detection unit control circuit recognizes circumstances of operation of the driven member based on information obtained from the voltage detection circuit, and varies the state of drive of the detection unit.

This makes it possible to vary the manner in which the detection unit is driven, via the detection unit control circuit according to the information obtained from the voltage detection circuit. Therefore, if the electronic apparatus is urged to use a small-sized battery that suffers from a voltage level drop as a result of electric power consumption or experiences great voltage level variations, the position detection accuracy possessed by the detection unit can be maintained while achieving power saving.

The present invention also provides an electronic apparatus in which the aforementioned detection unit control circuit intermittently drives the detection unit described above. Thus, the drive frequency of the intermittent drive is varied according to circumstances of operation of the driven member.

In this way, the detection unit can be driven intermittently. Also, the drive frequency can be varied. Therefore, an electronic apparatus producing the above-described effects can be accomplished. In addition, the electronic apparatus achieves power saving and can cope with a wider range of circumstances of operation of the driven member.

In an electronic apparatus in accordance with the present invention, the above-described detection unit control circuit intermittently drives the detection unit. The duty ratio of the intermittent drive is varied according to circumstances of operation of the driven member.

In this manner, the detection unit can be driven intermittently. The duty ratio of the intermittent drive can be varied. Therefore, the aforementioned effects of the present invention can be produced. Additionally, the accuracy of the detection unit can be maintained while achieving power saving in spite of variations in environments where the detection unit is driven such as power supply level variations.

In the electronic apparatus in accordance with the present invention, the above-described detection unit is an optical sensor comprising a light-emitting device and a light-receiving device.

In this configuration, it is easy to vary the manner in which the detection unit is driven by the detection unit control circuit, because the optical sensor is used. The aforementioned effects of the present invention can be intensified.

In the electronic apparatus in accordance with the present invention, the aforementioned power source has a first power source for displaying information about the time and a second power source for displaying information different from the time. The above-described driven member has a first driven member driven by the first power source and a second driven member driven by the second power source. The display member has a first display member driven by the first driven member and a second display member driven by the second driven member.

In consequence, an electronic apparatus which achieves power saving, has high positioning accuracy, and is capable of displaying plural kinds of information can be accomplished.

The present invention also provides an electronic apparatus in which at least one of the aforementioned power sources is a piezoelectric actuator built using a piezoelectric ceramic.

Thus, the piezoelectric actuator produces a large force. In addition, the driven members can be driven in minute steps. Therefore, the positions of the driven members can be detected accurately although the power saving is achieved. Also, the positioning resolution of the electronic apparatus can be enhanced.

The present invention also provides an electronic apparatus in which the above-described piezoelectric actuator has an ultrasonic motor comprising a piezoelectric vibrator having the aforementioned piezoelectric ceramic, a moving body for producing a driving force by vibrating waves generated by the piezoelectric vibrator, and a pressure application member for pressing the piezoelectric vibrator and the moving body into contact with each other.

As a result, a rotary piezoelectric actuator, i.e., a piezoelectric motor, can be easily constructed. Therefore, it is easy to combine it with the detection unit. This also yields the advantage that positions can be detected with less power consumption.

### BRIEF DESCRIPTION OF THE DRAWINGS

FIG. 1 is a block diagram illustrating the structure of the system formed by an electronic apparatus 100 in accordance with Embodiment 1 of the present invention;

FIG. 2 is a view showing the structure of the electronic apparatus 100 in accordance with Embodiment 1 of the invention;

FIG. 3 is a view showing the structure of an optical sensor A 120 used in the electronic apparatus 100 in accordance with Embodiment 1 of the invention;

FIG. 4 is a view illustrating control signals in the electronic apparatus 100 in accordance with Embodiment 1 of the invention;

FIG. 5 is a block diagram illustrating the structure of the system formed by an electronic apparatus 200 in accordance with Embodiment 2 of the invention;

FIG. 6 is a view showing the structure of the electronic apparatus 200 in accordance with Embodiment 2 of the invention;

FIG. 7 is a plan view of the calendar portion of the electronic apparatus 200 in accordance with Embodiment 2 of the invention, the calendar portion displaying date information;

FIG. 8 is a vertical cross section of the calendar portion of the electronic apparatus 200 in accordance with Embodiment 2 of the invention, the calendar portion displaying date information;

FIG. 9 is a diagram illustrating control signals in the electronic apparatus 200 in accordance with Embodiment 2 of the invention in a normal state;

FIG. 10 is a diagram illustrating control signals in the electronic apparatus 200 in accordance with Embodiment 2 of the invention when an external correction is made;

FIG. 11 is a block diagram illustrating the structure of the system formed by an electronic apparatus 300 in accordance with Embodiment 3 of the invention;

FIG. 12 is a view showing the structure of the calendar portion of the electronic apparatus 300 in accordance with Embodiment 3 of the invention;

FIG. 13 is a circuit diagram of an ultrasonic motor driver circuit 380 in the electronic apparatus 300 in accordance with Embodiment 3 of the invention;

FIG. 14 is a diagram illustrating a voltage detection circuit 440 in the electronic apparatus 300 in accordance with Embodiment 3 of the invention;

FIG. 15 is a diagram illustrating control signals when the voltage of a battery 430 in the electronic apparatus 300 in accordance with Embodiment 3 of the invention has varied due to consumption of the battery capacity;

FIG. 16 is a vertical cross section of the related art electronic apparatus 500 where a photo interrupter is used to detect the positions of driven members; and

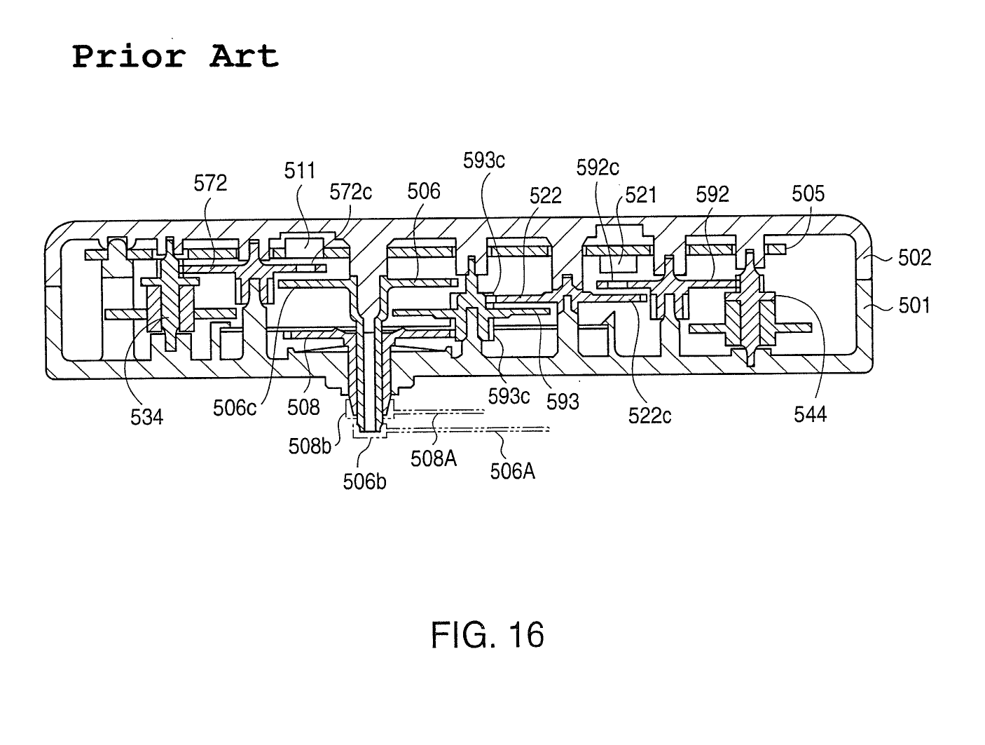

FIG. 17 is a plan view of the related art electronic apparatus where the photo interrupter is used to detect the positions of driven members.

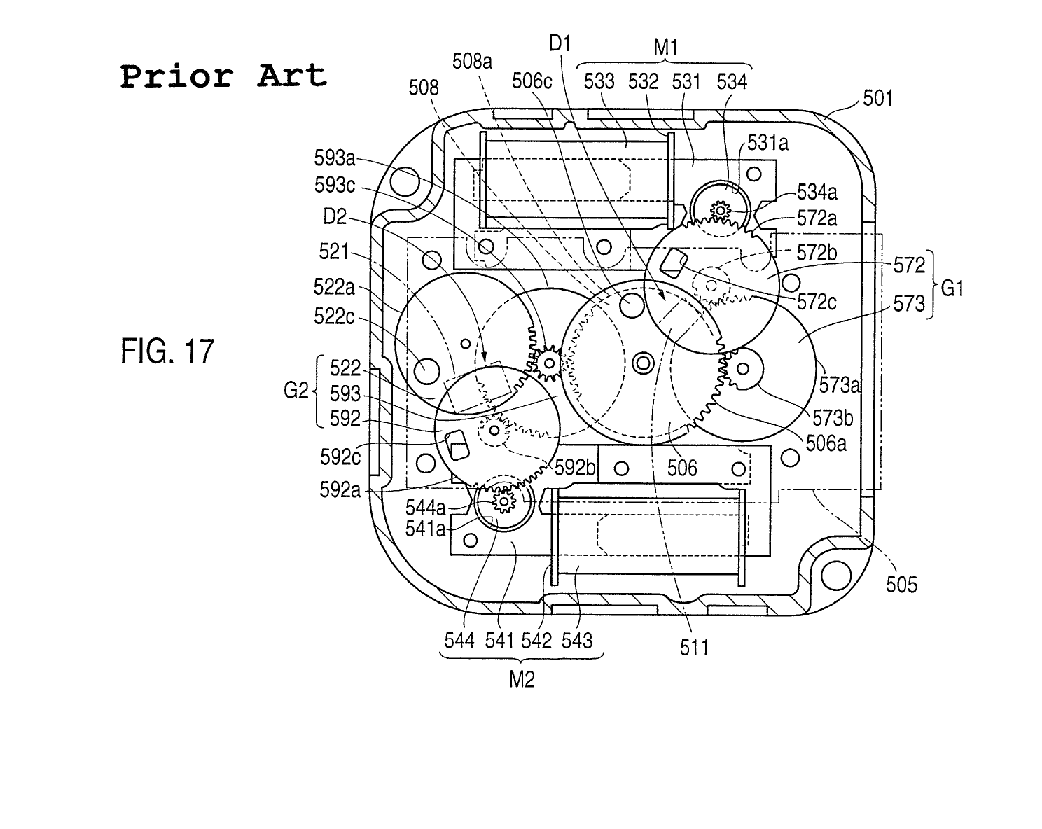

### DETAILED DESCRIPTION OF THE PREFERRED EMBODIMENTS

Embodiment 1

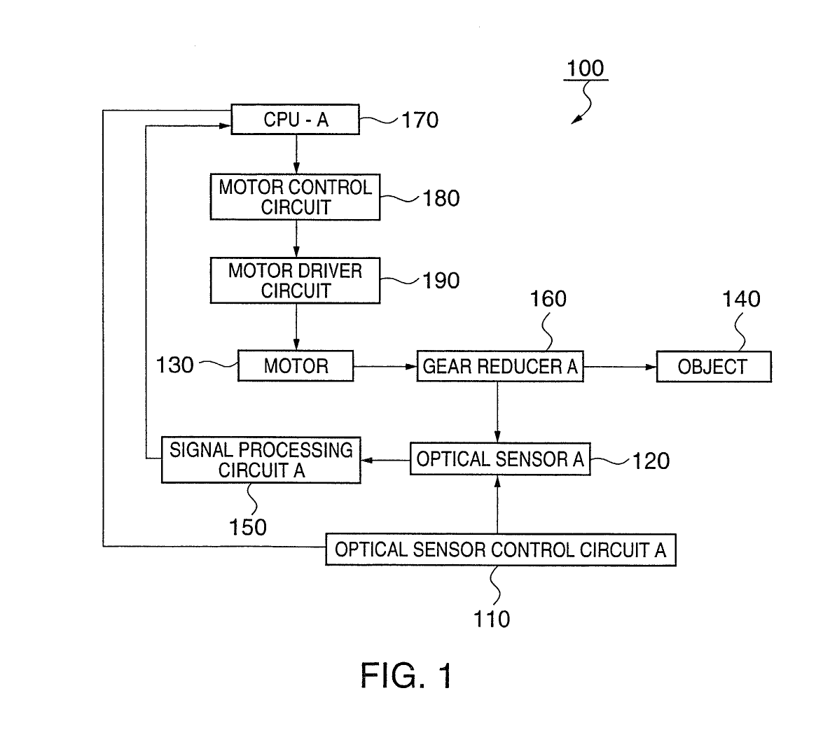

Embodiment 1 of the present invention is described by referring to FIGS. 1-4. An electronic apparatus, 100, in accordance with Embodiment 1 is an interior article that operates an object by electronic control. In this embodiment, the object is a doll, ornament, or the like that is an interior article.

FIG. 1 is a block diagram illustrating the structure of the system formed by the electronic apparatus 100. The electronic apparatus 100 comprises a CPU A 170 for controlling and managing the whole system of the electronic apparatus 100, a motor control circuit 180 for producing a signal to a motor driver circuit 190 to control an electric motor 130 according to an instruction from the CPU A 170, the motor driver circuit 190 for driving the motor 130 according to the signal from the motor control circuit 180, a gear reducer A 160 for transmitting the power of the motor 130 to an object 140 that is a driven member, an optical sensor A 120 acting as a detection unit for indirectly detecting the rotational position of the object 140 by detecting the rotational position of the gear reducer A 160, an optical sensor control circuit A 110 acting as a detection unit control circuit for varying the state of drive of the optical sensor A 120 according to circumstances of operation of the object 140, i.e., the rotational speed of the motor 130, and a signal processing circuit A 150 for processing the output signal from the optical sensor A 120.

The motor 130 is a stepping motor that is driven forward or rearward at two rotational speeds according to an instruction from the CPU A 170. That is, the motor control circuit 180 produces two kinds of drive frequencies to the motor driver circuit 190 according to an instruction from the CPU A 170. The motor 130 rotates at a speed corresponding to the drive frequency.

The CPU A 170 sends an instruction concerning starting, stoppage, rotational speed, and the direction of rotation to the motor control circuit 180 and, at the same time, sends a signal for controlling the state of drive of the optical sensor A 120 corresponding to the state of operation of the motor 130 to the optical sensor control circuit 110. The optical sensor control circuit 110 drives the optical sensor A 120 in two stages corresponding to two rotational speeds of the motor A 130. More specifically, the optical sensor A 120 is a reflection type photo interrupter comprising an LED and a phototransistor positioned within a plane. The optical sensor control circuit A 110 intermittently lights up the LED forming the optical sensor A 120 and consuming a large amount of electric power. In the present embodiment, the frequency of the emission of light is varied between two values according to the two rotational speeds of the motor 130 while maintaining the ON time of the light emission constant.

The rotational position of the object 140 is indirectly detected by the optical sensor A 120 from the rotational position of the gear reducer A 160. If this signal is processed by the signal processing circuit 150 and applied to the CPU A 170, this recognizes information about the position and drives or stops the object 140 according to a given pattern previously programmed into the CPU A 170. Also, the CPU varies the rotational speed and the direction of rotation of the object. A scanning function of an optical information apparatus or the like can be had by using a mirror or the like instead of the object 140 and modifying the control algorithm.

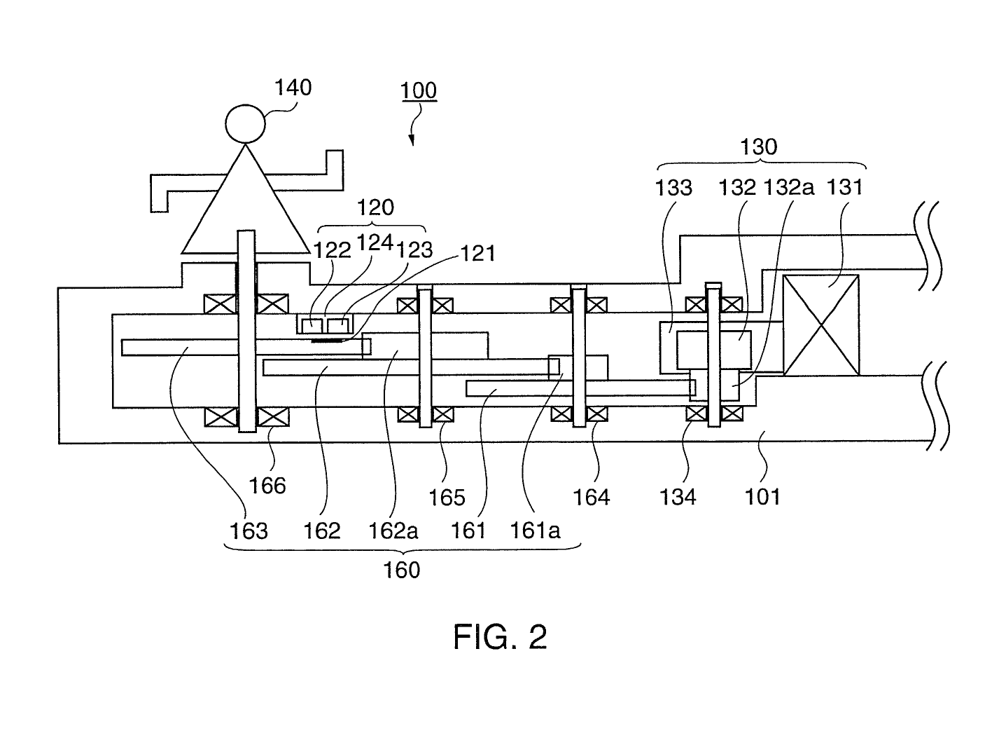

FIG. 2 is a view showing the structure of the electronic apparatus 100. This electronic apparatus 100 comprises an electric motor 130 comprising a coil 131, a stator 133, and a rotor 132, an object 140 acting as a driven member and driven by the motor 130, a gear reducer A 160 comprising toothed wheels 161, 162, and 163 and for transmitting the power of the motor 130 to the object 140, reflective plates 121 mounted on the surface of the toothed wheel 163, and an optical sensor A 120 mounted opposite to the surface of the toothed wheel 163 to detect passage of the reflective plates as the toothed wheel 163 is rotated.

The object 140 is mounted to the stem of the toothed wheel 163 and rotates with this wheel 163. The number of the reflective plates 121 is 12, and they are circumferentially equally spaced from each other on the surface of the toothed wheel 163. The optical sensor A 120 is a reflection type photo interrupter comprising an LED 122 acting as a light-emitting device and a phototransistor 123 acting as a light-receiving device. The optical sensor control circuit A 110 intermittently lights up the LED 122 at a frequency corresponding to the state of drive of the motor 130 obtained from the CPU A 170. During rotation of the toothed wheel 163 and when any one of the reflective plates 121 passes across the position opposite to the optical sensor A 120, light emitted from this LED 122 is reflected by the reflective plate 121. The reflected light is received by the phototransistor 123, which in turn produces a detection signal. The rotational position of the toothed wheel 163 is detected in this way and thus the position of the object 140 is recognized. The resolution of the position detection is determined by the number of reflective plates 121 and is 30 degrees in this embodiment. Positional information from the optical sensor A 120 is applied to the CPU A 170 via the signal processing circuit A 150. Velocity information about the object 140 and even acceleration information are calculated from the positional information and from the spacing of signal pulses.

To rotationally support the rotor 132 of the motor 130 and the stems of the toothed wheels 161, 162, 163 forming the gear reducer A 160, bearings 134, 164, 165, 166 are mounted in pairs within the casing 101 of the electronic apparatus 100. A rotor pinion 132a is mounted on the rotor 132 of the motor 130 to transmit power, and is in mesh with the toothed wheel 161. Similarly, a pinion 161a is mounted on the toothed wheel 161, and is in mesh with the toothed wheel 162. A pinion 162a is mounted on the toothed wheel 162 and in mesh with the toothed wheel 163.

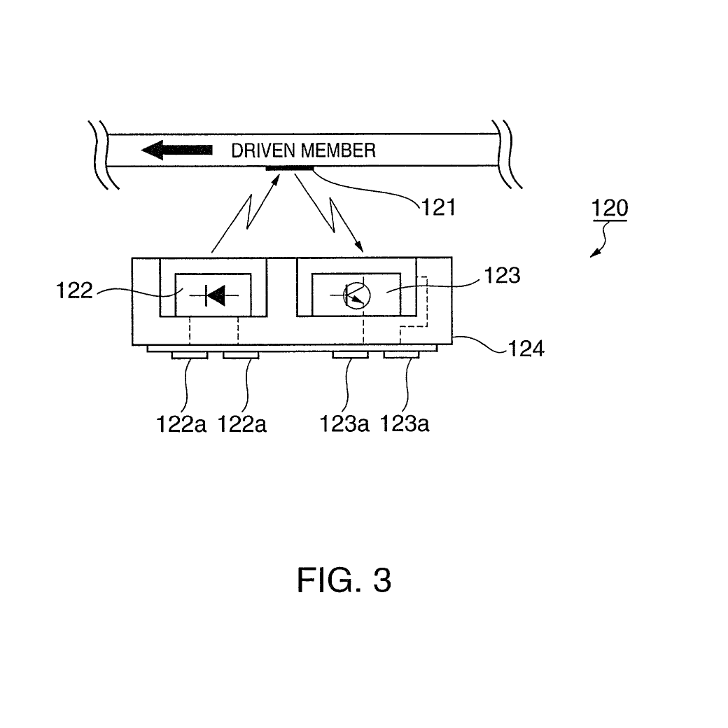

FIG. 3 is a view showing the structure of the optical sensor A 120 used in the electronic apparatus 100. The optical sensor A 120 is a reflection type photo interrupter comprising an LED 122 acting as a light-emitting device and a photo transistor 123 acting as a light-receiving device. Both devices are arranged in a plane within a package 124. An electrode 122a for supplying electric power to the LED 122 for light emission and another electrode 123a are mounted on the underside of the package 124. When the phototransistor 123 receives light reflected from any one of the reflective plates 121, the electrode 123a is used to deliver a detection signal to the signal processing circuit 150. A control signal from the optical sensor control circuit A is applied to 122a.

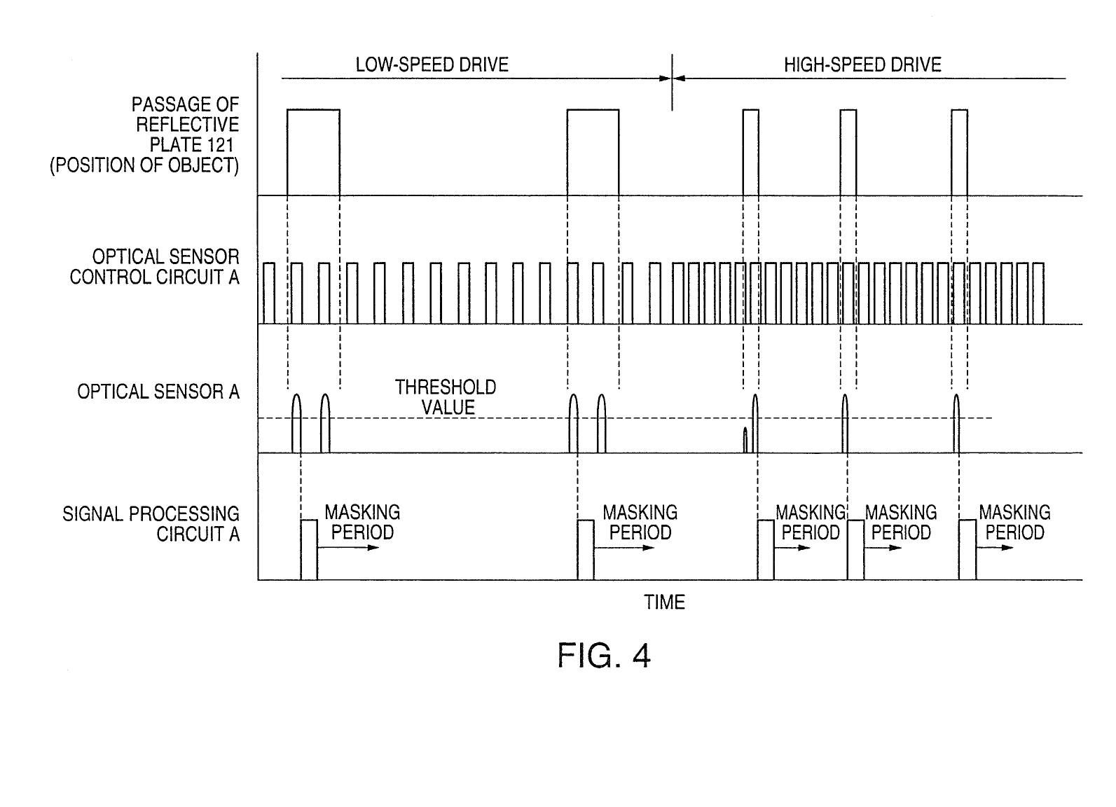

FIG. 4 is a diagram illustrating control signals in the electronic apparatus 100. This electronic apparatus 100 is an electronically controlled interior article for operating an object 140 according to a program previously loaded in a memory. Accordingly, an electric motor 130 for driving the object 140 starts, stops, or switches the direction of rotation in response to the output signal from the CPU A 170 in accordance with the program written in the memory (not shown). In addition, the motor varies its rotational speed. These drive and control of the object 140 are carried out while detecting positional information by the optical sensor A 120. The positional information is obtained when any of the reflective plates 121 mounted on the toothed wheel 163 passes across the position opposite to the optical sensor A 120 as described above.

The top graph of FIG. 4 indicates the manner in which each reflective plate 121 passes across the position opposite to the optical sensor A 120. Time is plotted on the horizontal axis. When the motor 130 is being driven at a low speed, the interval between the instant when the first one of the 12 reflective plates 121 passes the optical sensor A 120 and the instant when the second one passes it is prolonged. In other words, the time for the first reflective plate 121 to pass across the position opposite to the optical sensor A 120 is prolonged. On the other hand, where the motor 130 is being driven at a high speed, the individual reflective plates 121 pass the sensor at shorter intervals of time, as can be seen from the diagram. That is, the time for each reflective plate to pass the position is shortened.

The second graph indicates the output signal from the optical sensor control circuit A 110. The CPU A 170 issues a START instruction to the motor control circuit A 180. At the same time, an instruction for driving the optical sensor A 120 is also sent to the optical sensor control circuit A 110. The optical sensor A 120 is intermittently driven at a given frequency by the optical sensor control circuit A 110. That is, the LED 122 is made to emit intermittently. This intermittent emission operation is effective in reducing the electric power consumption. However, where the rotational speed of the driven member varies, intermittent emission will induce misdetection. Specifically, there arises the problem that where the driven member passes the optical sensor at a high speed, the member passes the sensor during the interval between successive emissions.

Therefore, in the electronic apparatus 100, the drive frequency of the intermittent operation for light emission is made higher than during low-speed operation only when the motor 130 is being driven at a high speed, as indicated by the second graph. That is, an instruction is given to the optical sensor control circuit A 110 from the CPU A 170, so that the optical sensor control circuit A flickers the LED 122 of the optical sensor A 120 at a high frequency. This can greatly reduce the electric power necessary to detect the object 140. In this embodiment, the emission frequency is switched between two levels according to the rotational speed of the motor 130. The period during which the emission is maintained, i.e., the ON time, is kept constant if the emission frequency is varied.

The third graph indicates the output signal from the optical sensor A 120. During the period when any one of the reflective plates 121 mounted on the toothed wheel 163 is passing across the position opposite to the optical sensor A 120 and the LED 122 is emitting light, the phototransistor 123 receives the light reflected from the reflective plate 121 and creates a pulse signal of a pulse width substantially equal to the duration.

The fourth graph indicates the output signal from the signal processing circuit A 150. Only when the level of the output pulse from the optical sensor A 120 exceeds a preset threshold value as shown, the signal processing circuit A 150 detects the falling edge of the pulse, creates a pulse having a certain time width, and applies a pulse as positional information about the object 140 to the CPU A 170. As can be seen from the graph, when any one of the reflective plates 121 is passing across the position of the optical sensor A 120, the optical sensor A 120 may produce two or more pulses. In this case, the signal processing circuit A 150 detects the falling edge of the first pulse and creates a pulse as positional information. Then, a masking period is established to inhibit the above-described processing for creating a pulse in response to the output signal from the optical sensor A 120 during a preset period. Therefore, the apparatus is so designed that only one pulse is created at all times as positional information in response to passage of one reflective plate 121. The output pulses from the signal processing circuit A 150 are applied to the CPU A 170, which counts the number of the pulses. If the CPU counts up to the number of pulses previously written in the program stored in the memory (not shown), the CPU sends a given signal to the motor control circuit 180 to vary the state of drive of the motor 130 for changing the next state of drive of the object 140 (i.e., whether the direction of rotation is switched, the rotational speed is varied, or the object is brought to a stop).

In the description of the present embodiment, the optical sensor A 120 is a reflection type photo interrupter. It may also be a transmissive type photo interrupter. Furthermore, a magnetic detection unit using a magnetoresistive device or Hall device may be used with similar utility.

As described thus far, in the electronic apparatus 100 forming Embodiment 1 of the present invention, the optical sensor A 120 for detecting the position of the object 140 is driven intermittently. The optical sensor A 120 is driven and controlled according to the rotational speed of the motor 130 acting as a power source by the optical sensor control circuit A 110. In addition, the above-described signal processing is performed. Thus, the electric power necessary for the position detection can be reduced to a minimum while maintaining the high accuracy and reliability of detection of the position of the object.

Embodiment 2

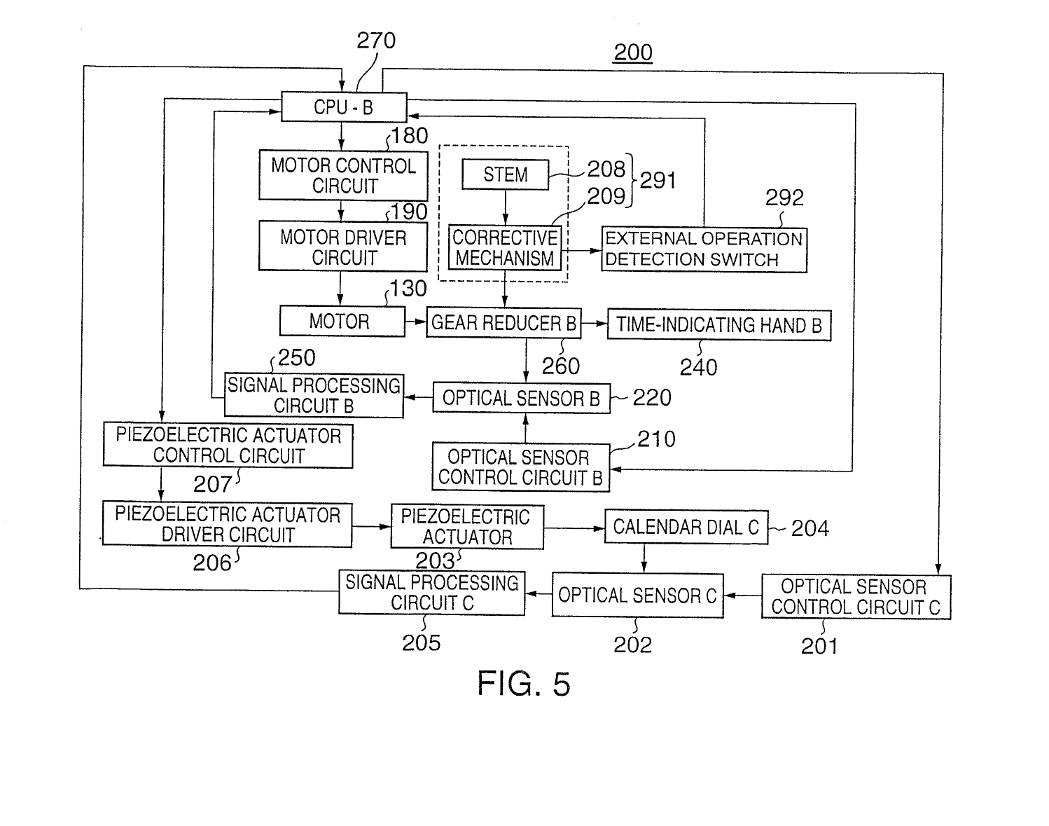

Embodiment 2 of the present invention is described by referring to FIGS. 5-10. An electronic apparatus, 200, in accordance with Embodiment 2 of the invention is an electronic timepiece that has hands for displaying information about the time and a calendar function of displaying information about the date. The timepiece is also equipped with a function of detecting positions to electronically control the time hands and the calendar dial.

FIG. 5 is a block diagram illustrating the structure of the system of the electronic apparatus 200. This electronic apparatus 200 comprises an electric motor 130 acting as a power source in the present invention, time-indicating hands B 240 driven by the motor 130 and acting as driven members in the invention, a gear reducer B 260 for transmitting the power of the motor 130 to the time-indicating hands B 240, an optical sensor B 220 acting as a detection unit in the present invention which indirectly detects the rotational positions of the time-indicating hands 240 by detecting the rotational position of the gear reducer B 260, an optical sensor control circuit B 210 acting as a detection unit control circuit in the present invention that varies circumstances of operation of the time-indicating hands 240 (i.e., for varying the state of drive of the optical sensor B 220 according to the rotational speed of the motor 130), a signal processing circuit B 250 for processing the output signal from the optical sensor B 220, a CPU B 270 for controlling and managing the whole system of the electronic apparatus 200, a motor driver circuit 190 for driving the motor 130, and a motor control circuit 180 for controlling the motor 130 according to an instruction from the CPU B 270 and producing a signal to the motor driver circuit 190. In this embodiment, the motor 130 is a stepping motor. The motor control circuit 180 delivers a drive frequency of the motor 130 according to an instruction from the CPU B 270 to the motor driver circuit 190. The motor 130 rotates at a speed corresponding to the drive frequency.

This structure is similar to the electronic apparatus 100 in accordance with Embodiment 1 except that this structure has an external corrective unit 291 for correcting the positions of the time-indicating hands B 240 and an external operation detection switch 292 acting as an external operation detection unit for detecting the state of operation of the external corrective unit 291. This corrective unit 291 consists of a stem 208 and a corrective mechanism 209.

If an external force such as a human force is applied to the stem 208, this external force is applied to the corrective mechanism 209 and then to the gear reducer B 260 for transmitting the power of the motor 130 to the time-indicating hands B 240, whereby the time-indicating hands B 240 can be modified. At this time, if the stem 208 is operated, the corrective mechanism 209 operates. Interlocking with the operation of the corrective mechanism 209, the external operation detection switch 292 operates. In this way, information indicating that an external operation is done is transmitted to the CPU B 270.

Furthermore, the electronic apparatus 200 comprises a calendar dial C 204 acting as a second driven member for displaying information about the date, a piezoelectric actuator 203 acting as a second power source for driving the calendar dial C 204, a piezoelectric actuator driver circuit 206 for driving the piezoelectric actuator 203, a piezoelectric actuator control circuit 207 for controlling the piezoelectric actuator 203 according to an instruction from the CPU B 270 and producing an output signal to the piezoelectric actuator driver circuit 206, an optical sensor C 202 provided to detect the rotational position of the calendar dial C 204 driven by the piezoelectric actuator 203, an optical sensor control circuit C 201 for intermittently driving the optical sensor C 202 according to the signal produced together with an instruction for driving the piezoelectric actuator 203 from the CPU B 270, and a signal processing circuit C 205 for processing the output signal from the optical sensor C 202 and transmitting information about the position of the calendar dial C 204 to the CPU B 270. The calendar dial C 204 is impressed with numerals 1 through 31.

First, the CPU B 270 delivers a pulse signal of 1 Hz to the motor control circuit 180, which in turn applies a signal to the motor driver circuit 190 to drive the motor 130 in steps at 1 Hz. The motor 130 is stepped through 180 degrees every second. The power of the motor 130 is transmitted to the gear reducer B 260 to drive the time-indicating hands B 240. The optical sensor B 220 detects the position of “zero o'clock” of the time-indicating hands B 240, and sends information indicating detection of the position to the CPU B 270 via the signal processing circuit B 250. Simultaneously with start of drive of the motor 130, the CPU B 270 issues an instruction also to the optical sensor control circuit B 210 to intermittently drive the optical sensor B 220.

If the CPU B 270 recognizes that the time-indicating hands B 240 have reached the zero o'clock position, the CPU sends a signal for driving the piezoelectric actuator 203 to the piezoelectric actuator control circuit 207. The piezoelectric actuator driver circuit 207 causes the piezoelectric actuator 203 to drive the calendar dial C 204. The CPU B 270 gives an instruction to the piezoelectric actuator control circuit 207 to drive the piezoelectric actuator 203. Simultaneously, the CPU sends an instruction to the optical sensor control circuit C 201 to intermittently drive the optical sensor C 202. The optical sensor C 202 detects that the calendar dial C 204 has moved through a rotational angle corresponding to one day, and information indicating the detection signal is transmitted to the CPU B 270 via the signal processing circuit C 205. The CPU B 270 recognizes that the calendar dial C 204 has rotated through a rotational angle corresponding to one day and produces an output signal to the piezoelectric actuator control circuit 207 to stop the drive of the actuator 203. In this way, the CPU stops the piezoelectric actuator 203.

Normal state of the electronic apparatus 200 has been described thus far. If the stem 208 is manually operated, the corrective mechanism 209 interlocks with the stem 208. This turns on the externally operated detection switch. Information indicating that the time-indicating hands B 240 are modified externally is applied to the CPU B 270. Based on the information from the external operation detection switch, the CPU B 270 sends an output signal to the optical sensor control circuit B 210 to modify the state of intermittent drive of the optical sensor B 220 that detects the positions of the time-indicating hands B 240. That is, the system is so designed that when the external corrective unit 291 starts to operate in response to a human operation, the state of the intermittent drive of the optical sensor B 220 monitoring the zero o'clock position of the time-indicating hands B 240 varies.

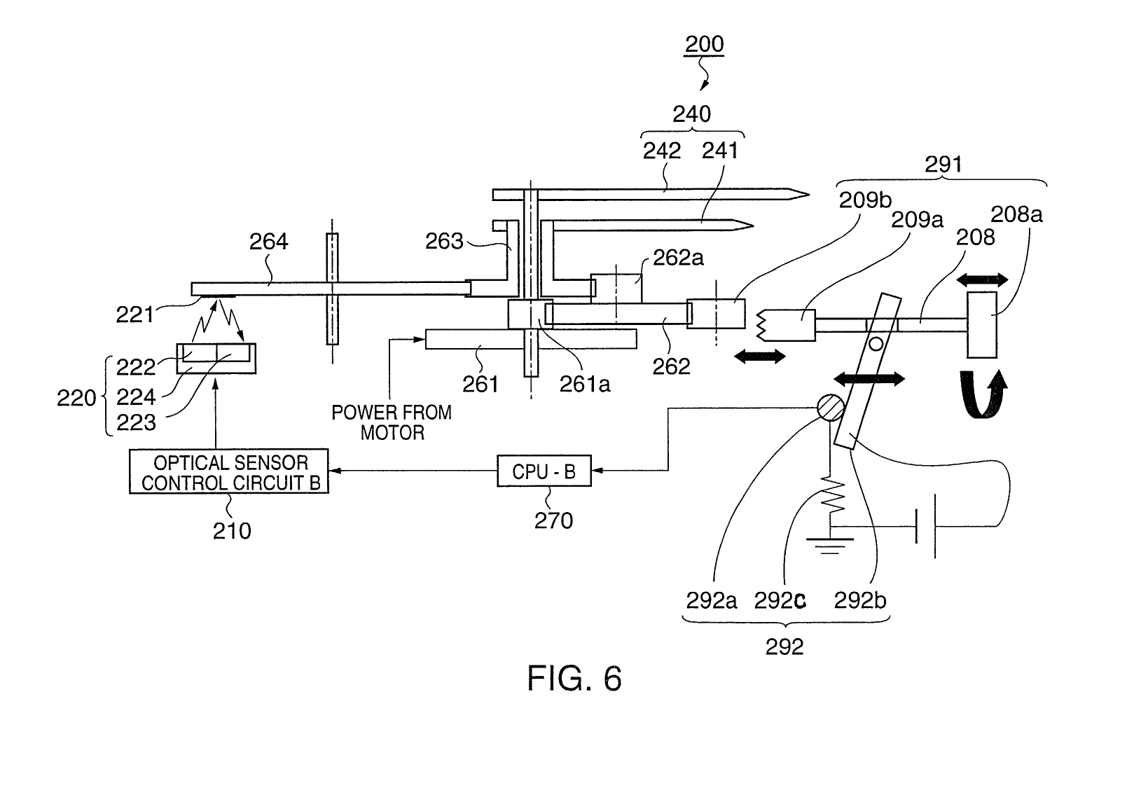

FIG. 6 is a view illustrating the structure of the electronic apparatus 200. The gear reducer B 260 comprises a reduction gear train (not shown) for transmitting the power of the motor 130, a second gear 261 for further reduction, a second pinion 261a integral with a shaft fitted to slip when an external force more than a given value is applied to the second gear 261, a minute wheel 262 meshing with the second pinion 261a, a minute pinion 262a mounted integrally with the minute wheel 262, a cylindrical wheel 263 in mesh with the minute pinion 262a, and a 24-hour wheel 264 in mesh with the cylindrical wheel 263 and rotating once in 24 hours. The time-indicating hands B 240 comprise a minute hand 242 mounted to the end of the cylindrical wheel 263 and indicating information about the minute, and an hour hand 241 mounted to a shaft rotating with the second pinion 261a at all times to indicate the hour.

The external corrective unit 291 comprises a stem 208, a winder 208a mounted to an end of the stem 208 to permit a person to operate the stem 208, a clutch wheel 209a mounted to the other end of the stem facing away from the winder 208a, and a setting wheel 209b forming a part of the gear reducer B 260 and in mesh with the minute wheel 262. If the stem 208 is moved to the left as shown, the clutch wheel 209a mounted at one end of the stem 208 comes into mesh with the setting wheel 209b. Under this condition, if the stem 208 is manually rotated, the rotation of the stem 208 is transmitted to the setting wheel 209b and then to the second pinion 261a and cylindrical wheel 263 via the minute wheel 262. Thus, the minute hand 242 and the hour hand 241 can be modified by a human operation.

The external operation detection switch 292 that is an external operation detection unit comprises a swinging switch lever 292b, a switch pin 292a, and a resistor 292c. The swinging switch lever 292b interlocks with horizontal movement of the stem 208 as indicated by the arrow and is electrically connected with the positive terminal of a battery 299. As the stem 208 moves horizontally (i.e., right or left), the switch pin 292a comes into contact with the switch lever 292b. The resistor 292c is connected with the negative terminal of the battery 299 and with the switch pin 292a.

An optical sensor B 220 is mounted in a position opposite to the 24-hour wheel 264. A single reflective plate 221 is mounted on the surface of the 24-hour wheel 264. The optical sensor B 220 is of the same type as the optical sensor used in the electronic apparatus 100 described previously. When the LED 222 that is a light-emitting device emits light, it is reflected by the reflective plate 221 and received by the phototransistor 223 that is a light-receiving device. In this way, the instant when the hour hand 241 reaches the zero o'clock position is detected.

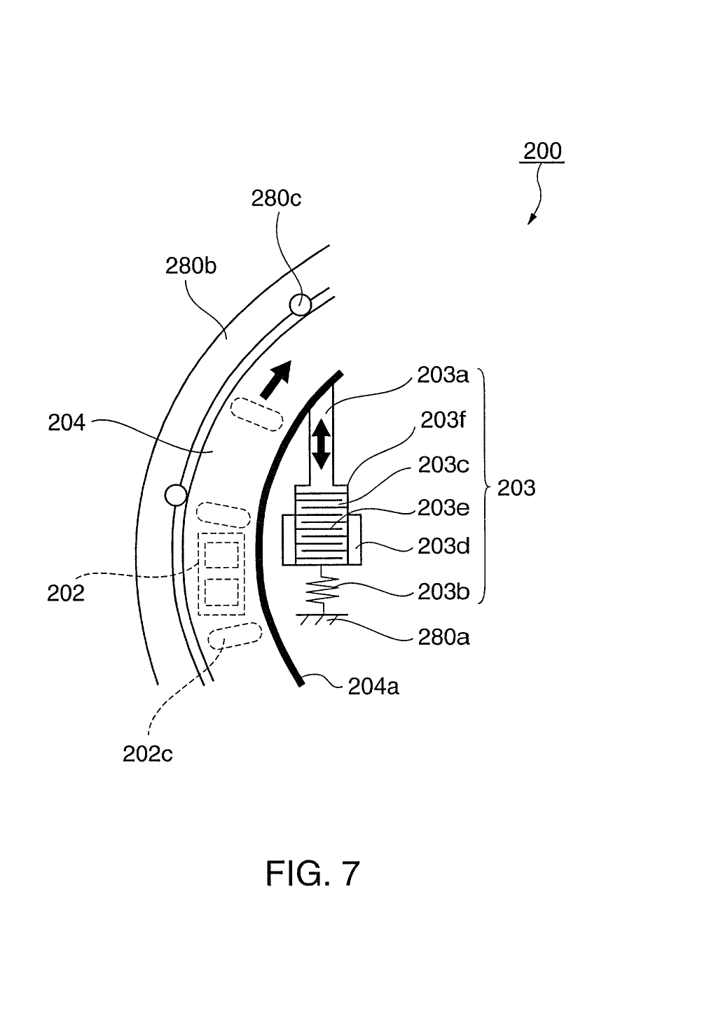

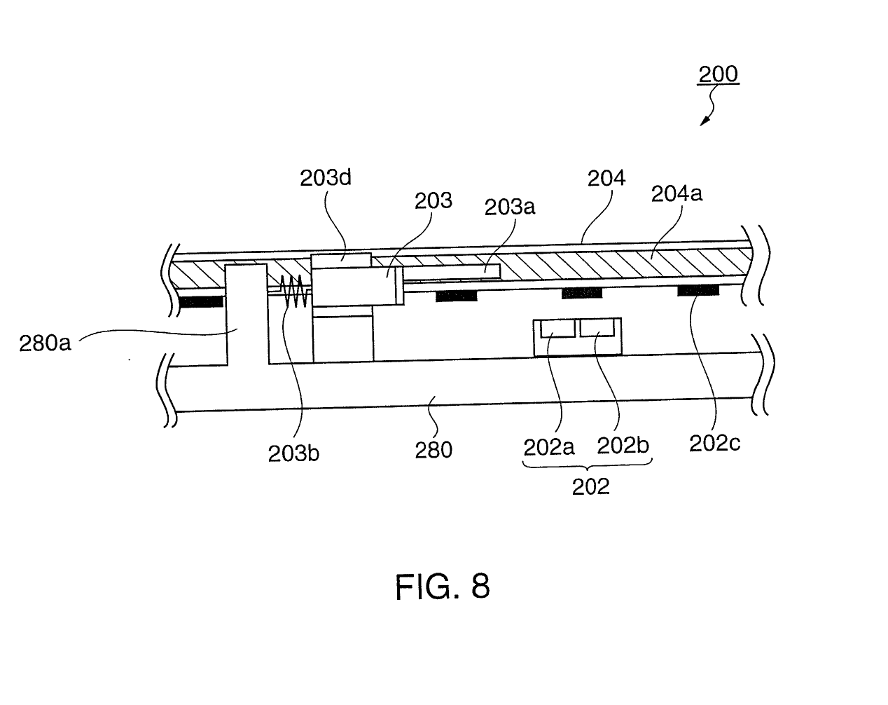

FIG. 7 is a plan view of the calendar portion of the electronic apparatus 200 indicating information about the date. FIG. 8 is a vertical cross section of this portion. A calendar dial C 204 that is a second driven member is an annular plate member. Numerals indicating dates from “1” to “31” are printed on the surface. The calendar dial is directly driven by the non-resonant piezoelectric actuator 203. This piezoelectric actuator 203 is of the lamination type and has a protrusion 203a. The piezoelectric actuator 203 is positioned close to the inner surface of the calendar dial C 204. A pressure application spring 203b presses the protrusion 203a of the piezoelectric actuator 203 into contact with the calendar dial C 204 to drive it directly by a frictional force.

A sliding plate 204a for sliding over the protrusion 203a is stuck to the inner surface of the calendar dial C 204. Preferably, this sliding plate 204a is made of engineering plastics having a large frictional coefficient and has excellent wear resistance. The piezoelectric actuator 203 is supported by a support member 203d so as to be slidable in the lamination direction of piezoelectric elements 203c. The pressure application spring 203b is mounted to a protruding portion 280a protruding from a base plate 280 of the electronic apparatus 200. The number of the stacked piezoelectric elements 203c of the piezoelectric actuator 203 is 100. Almost full-size electrodes 203e are sandwiched between the successive piezoelectric elements 203c. The electrodes are stacked and sintered. Alternate ones of the electrodes 203e are treated as one set and shorted by an external electrode 203f. The 100 stacked piezoelectric elements 203c are connected in parallel. This lamination type piezoelectric actuator 203 is fabricated by a green sheet lamination process. The front end of the protrusion 203a is cut obliquely. The piezoelectric actuator 203 is so arranged that the direction of protrusion is parallel to the tangential direction to the inner surface of the calendar dial C 204. This determines the angle of contact. The calendar dial C 204 is rotatably held to the outer fringe 280b of the base plate 280 via ball bearings 280c.

The optical sensor C 202 is placed on the surface of the base plate 280 in the position opposite to the calendar dial C 204. Thirty-one reflective plates 202c are circumferentially equally spaced from each other on the surface of the calendar dial C opposite to the optical sensor C 202. This optical sensor C 202 is of the same type as the optical sensor B 220 used to detect the positions of the above-described time-indicating hands B 240, and comprises an LED 202a and a phototransistor 202b arranged within a plane.

If the CPU B 270 recognizes that the time-indicating hands B 240 detect the zero o'clock position, the CPU B 270 issues an instruction to the piezoelectric actuator control circuit 207 to drive the piezoelectric actuator 203. Also, the CPU produces a signal to the optical sensor control circuit C 201 to drive the optical sensor C 202 intermittently. If any one of the reflective plates 202c arrives at the position opposite to the optical sensor C 202, the optical sensor C 202 produces a detection signal and transmits information indicating that the calendar dial C 204 has been driven a distance corresponding to one day to the CPU B 270 via the signal processing circuit C 205. The CPU B 270 then produces a signal to the piezoelectric actuator control circuit 207 to stop the piezoelectric actuator 203. The CPU also produces a signal to the optical sensor control circuit C 201 to cause it to deactivate the optical sensor C 202.

At this time, the piezoelectric actuator driver circuit 206 applies an alternating voltage of a given frequency to the piezoelectric actuator 203 based on the output signal from the piezoelectric actuator control circuit 207. The piezoelectric actuator 203 produces elongating and contracting displacements in the direction of lamination of the piezoelectric elements 203c in response to the alternating voltage. This causes the protrusion 203a to push against the calendar dial C 204, thus directly driving it. Where this piezoelectric actuator 203 is used, direct drive can be accomplished because a large force is generated. This dispenses with a speed reduction mechanism. This greatly simplifies the structure of the calendar portion. Furthermore, the apparatus is not affected by backlash or the like because there is no intervening speed reduction mechanism. Accurate drive and control that are features of position detection using the optical sensor C 202 can be accomplished.

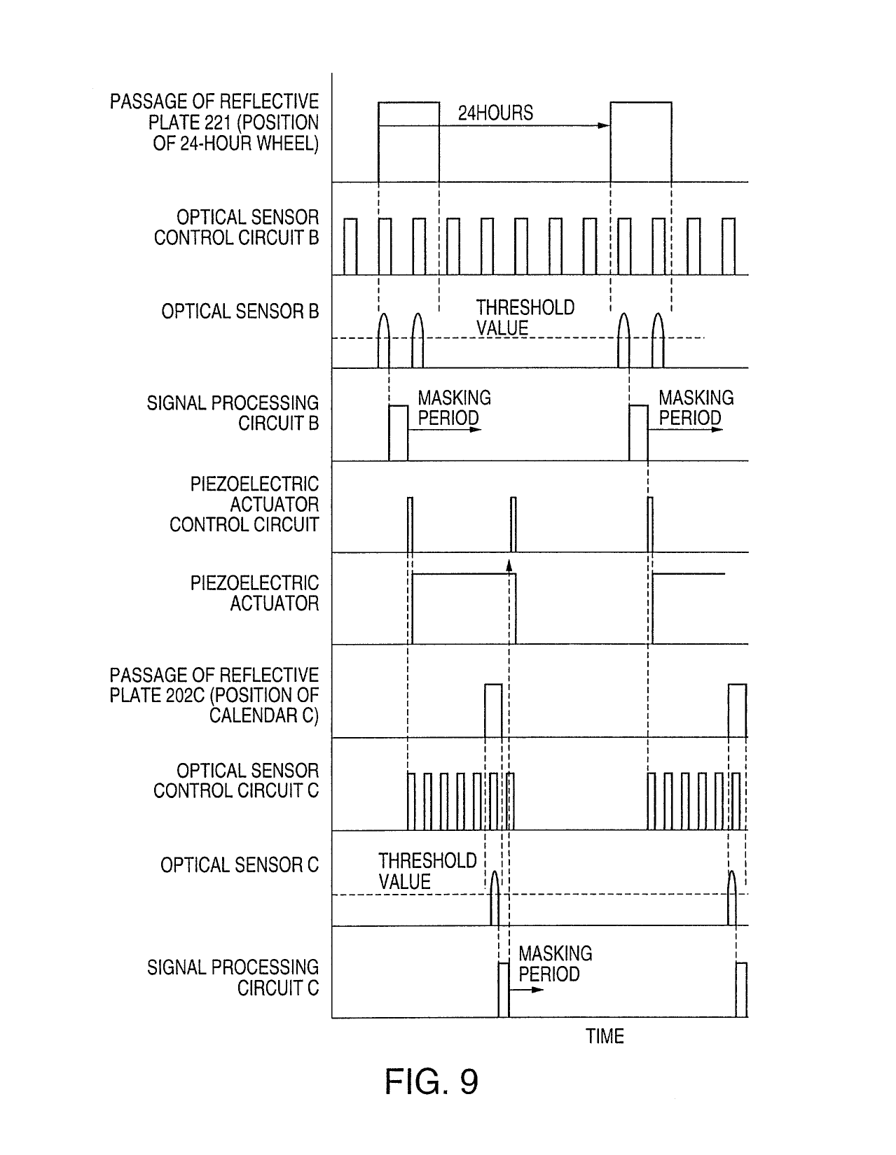

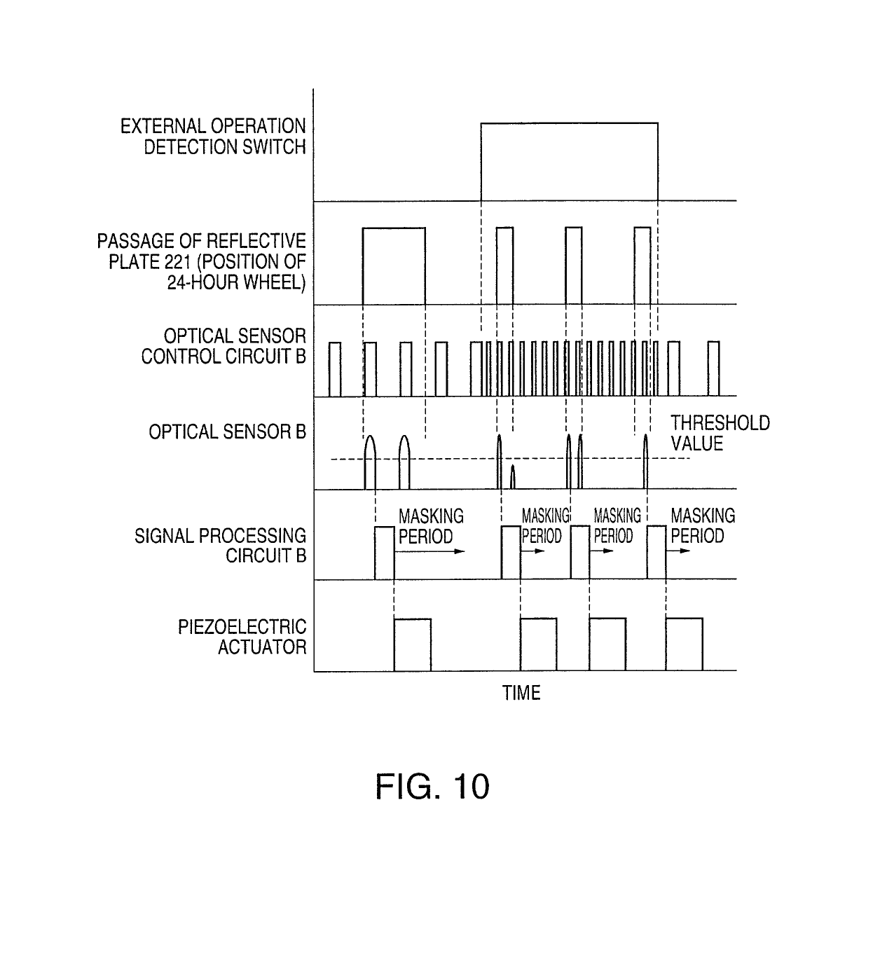

Control signals in the electronic apparatus 200 are described by referring to FIGS. 9 and 10. FIG. 9 shows the control signals in the electronic apparatus 200 under normal conditions. FIG. 10 shows the control signals during external modification. In both figures, the horizontal axis indicates time.

The operation under normal conditions is first described by referring to FIG. 9, which indicates the manner in which a reflective plate 221 mounted on the 24-hour wheel 264 passes across the position opposite to the optical sensor B 220. Time is plotted on the horizontal axis. The reflective plate 221 passes across the position opposite to the optical sensor B 220, once in 24 hours. In this example, there is only one reflective plate 221. To detect the position crossed by the reflective plate 221, the optical sensor control circuit B 210 drives the optical sensor B 220 at a given frequency and at a constant duty ratio. When the reflective plate 221 mounted on the 24-hour wheel 264 reaches the position opposite to the optical sensor B 220 at intervals of 24 hours, the optical sensor B 220 produces a detection pulse. At this time, a threshold value is established.

Of the output pulses from the optical sensor B 220 produced in response to the passage of the reflective plate 221, the falling edge of the pulse that exceeds the threshold value first is detected, and a signal is produced to the signal processing circuit B 250. A pulse is generated to create information indicating that the time-indicating hands B 240 have reached the zero o'clock position. Then, a masking period is established to inhibit for a preset period the above-described pulse generation processing in spite of the output signal from the optical sensor B 220. Therefore, only one pulse is generated in response to one pass of the reflective plate 221.

Then, on receiving the output pulse from the signal processing circuit B 250, the CPU B 270 recognizes that the time-indicating hands B have reached the zero o'clock position, and issues an instruction to the piezoelectric actuator control circuit 207 to drive the piezoelectric actuator 203. The piezoelectric actuator control circuit 207 produces a single pulse to the piezoelectric actuator driver circuit 206. The piezoelectric actuator driver circuit 206 receives the single pulse from the piezoelectric actuator control circuit 207 and drives the piezoelectric actuator 203 at a given alternating voltage. This rotates the calendar dial C and detects the motion of the reflective plate 221 mounted on the calendar dial C 202. The output signal from the optical sensor control circuit C 201 is shown. The CPU B 270 gives an instruction to the piezoelectric actuator control circuit 207 to drive the piezoelectric actuator 203 and, at the same time, gives an instruction to the optical sensor control circuit C 201 to drive the optical sensor C 202. On receiving it, the optical sensor control circuit C 201 produces an output signal to intermittently drive the optical sensor C 202. The optical sensor C 202 driven intermittently detects the passage of the reflective plate 221 mounted on the calendar dial C and produces an output pulse.

The signal processing circuit C 205 detects the falling edge of the first one of output pulses from the optical sensor C 202 higher than a preset threshold value and creates a pulse signal. The signal processing circuit informs the CPU B 270 that the calendar dial C 204 has been driven a distance corresponding to one day. The CPU B 270 produces a signal to the piezoelectric actuator control circuit 207 to stop the piezoelectric actuator 203.

As shown in the fifth graph, the piezoelectric actuator control circuit 207 produces one pulse to the piezoelectric actuator driver circuit 206 to stop the operation of the piezoelectric actuator 203.

Control signals on external modification are next described by referring to FIG. 10. First, if the stem 208 is manually operated, the swinging switch lever 292b at the positive terminal level (H level) of the battery is brought into contact with a switch pin 292a at the positive terminal level (L level) of the battery in interlock with the operation of the stem 208. The switch pin 292a is connected with a port of the CPU B 270. Under normal conditions where the swinging switch lever 292b is not in contact with the switch pin 292a and the external operation detection switch 292 is OFF, L level is applied to the CPU B 270. If the external operation detection switch 292 is turned ON, H level is applied as shown in FIG. 6.

It can be seen that during external modification, the rotational speed of the 24-hour wheel 264 is much higher than under normal conditions, and that the time for the reflective plate 221 to pass and the intervals at which the reflective plate 221 passes are varied greatly. That is, the time for the plate to pass is shortened compared with the case of normal conditions. Also, the intervals at which the plate passes are shortened.

The CPU B 270 receives the H-level signal produced from the external operation detection switch and gives an instruction to the optical sensor control circuit B 210 to drive the optical sensor B 220 at a high frequency to avoid misdetection in anticipation of great increase of the rotational speed of the 24-hour wheel 264. In this case, the optical sensor B 220 varies the state of drive in such a way that only the drive frequency is varied while maintaining constant the duty ratio, to reduce the electric power consumption used for the detection to a minimum while maintaining the detection accuracy and the reliability of the detection.

A pulse is generated as information indicating that the falling edge of the first one of output pulses delivered from the optical sensor B 220 in response to passage of the reflective plate 221 and exceeding a preset threshold value has been detected and that the time-indicating hands B 240 have reached zero o'clock position. Then, a masking period is established to inhibit the aforementioned pulse generation processing for a preset period in spite of the output signal from the optical sensor B 220. Therefore, only one pulse is generated in response to one pass of the reflective plate 221.

Subsequently, signals are transmitted similarly to the case of normal conditions illustrated in FIG. 9 and so the description is omitted.

In the description of the present embodiment, reflection type photo interrupters are used as the optical sensor B 220 and as the optical sensor C 202. They may also be transmissive type photo interrupters. Furthermore, magnetic detection unit using magnetoresistive devices or Hall devices may be used with similar utility.

As described thus far, the electronic apparatus 200 in accordance with Embodiment 2 of the present invention has an external corrective function and so states of drive greatly different from those occurring under normal conditions can be expected. The electric power consumption associated with detection can be reduced greatly while maintaining the detection accuracy and the reliability of the detection by the optical sensor control circuit. Also, the apparatus has a function of displaying calendar information using a calendar dial that provides a great load. Direct drive can be accomplished by using a piezoelectric actuator. Also, the structure of the calendar portion can be made very simple. Furthermore, the apparatus is not affected by backlash or the like because there is no speed reduction mechanism. Accurate drive and control that are features of the detection of positions using an optical sensor can be accomplished with low electric power.

Embodiment 3

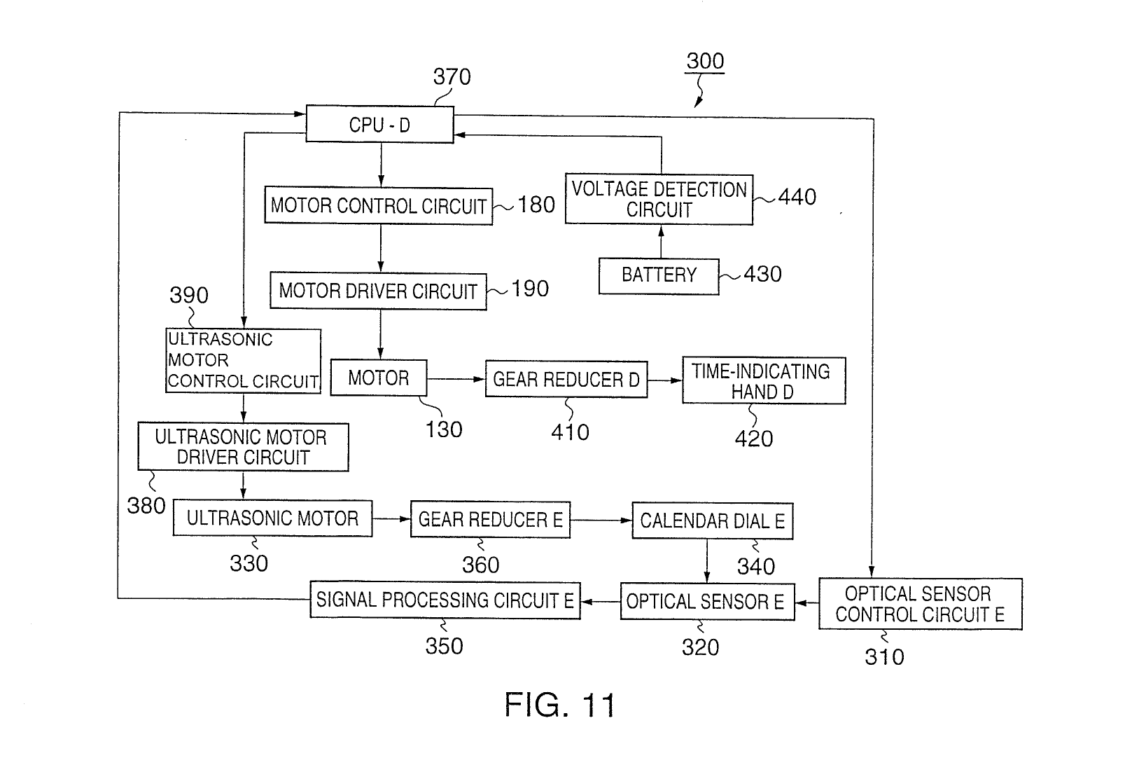

Embodiment 3 of the present invention is described by referring to FIGS. 11-15. An electronic apparatus, 300, in accordance with Embodiment 3 is an electronic timepiece that has hands for displaying information about the time and a calendar function for displaying information about the date. In addition, the timepiece has a function of detecting the positions and electronically controls the time hands and the calendar dial, in the same way as the electronic apparatus 200 described previously. This apparatus is widely different from the electronic apparatus 200 in that better detection and control are performed in response to variations in the battery voltage to reduce the electric power used for the detection. In this way, power saving is sought.

FIG. 11 is a block diagram illustrating the configuration of the system of the electronic apparatus 300. The electronic apparatus 300 comprises an electric motor 130 acting as a power source in the present invention, a time-indicating hand D 420 driven by the motor 130 and acting as a driven member in the present invention, a gear reducer D 410 for transmitting the power of the motor 130 to the time-indicating hand D 420, a CPU D 370 for controlling and managing the whole system of the electronic apparatus 300, a motor driver circuit 190 for driving the motor 130, and a motor control circuit 180 used to control the motor 130 in accordance with an instruction from the CPU D 370. The motor control circuit 180 produces an output signal to the motor driver circuit 190. In this embodiment, the motor 130 is a stepping motor. The motor control circuit 180 delivers a drive frequency of the motor 130 to the motor driver circuit 190 in accordance with an instruction from the CPU D 370. The motor 130 rotates at a speed corresponding to the drive frequency.

The zero o'clock position of the time-indicating hand D 420 is detected by a detection system (not shown) comprising components similar to the external corrective unit 291, external operation detection switch 292, optical sensor B 220, optical sensor control circuit B 210, and signal processing circuit B 250 used in the electronic apparatus 200. The detection system achieves power saving similarly to the electronic apparatus 200.

The structure of the calendar portion of the electronic apparatus 300 is different from the electronic apparatus 200, and comprises a calendar dial E 340 used to display information about the date and acting as a second driven member, an ultrasonic motor 330 used to drive the calendar dial E 340 and acting as a second power source, an ultrasonic motor driver circuit 380 for driving the ultrasonic motor 330, an ultrasonic motor control circuit 390 used to control the ultrasonic motor 330 in accordance with an instruction from the CPU D 370 and producing an output signal to the ultrasonic motor driver circuit 380, a gear reducer E 360 for transmitting the power of the ultrasonic motor 330 to the calendar dial E 340, an optical sensor E 320 mounted to detect the rotational position of the calendar dial E 340 driven by the ultrasonic motor 330, an optical sensor control circuit E 310 for intermittently driving the optical sensor E 320 according to an output signal produced together with the instruction to drive the ultrasonic motor 330 issued from the CPU D 370, and a signal processing circuit E 350 for processing the output signal from the optical sensor E 310 and transmitting information about the position of the calendar dial E 340 to the CPU D 370. The calendar dial E 340 is impressed with numerals from 1 through 31.

On recognizing that the time-indicating hand D 420 has reached the zero o'clock position, the CPU D 370 sends a signal to the ultrasonic motor control circuit 390 to drive the ultrasonic motor 330. The ultrasonic motor driver circuit 380 causes the ultrasonic motor 330 to drive the calendar dial E 340 via the gear reducer E 360. In this embodiment, the CPU D 370 issues an instruction to the ultrasonic motor control circuit 390 to drive the ultrasonic motor 330 and, at the same time, issues an instruction to the optical sensor control circuit E 310 to intermittently drive the optical sensor E 320. The optical sensor E 320 detects that the calendar dial E 340 has moved through a rotational angle corresponding to one day. The detection signal, or information, is transmitted to the CPU D 370 via the signal processing circuit E 350. The CPU D 370 recognizes that the calendar dial E 340 has rotated through a rotational angle corresponding to one day and produces an output signal to the ultrasonic motor control circuit 390 to deactivate the ultrasonic motor 330, thus stopping the ultrasonic motor 330.

The electronic apparatus 300 is characterized in that it further includes a voltage detection circuit 440 for detecting the voltage level of a battery 430. The voltage detection circuit 440 has a preset threshold value. When the battery voltage is in excess of the threshold value, the voltage detection circuit sends an H-level signal to the CPU D 370. When the battery voltage is below the threshold value, the voltage detection circuit sends an L-level signal to the CPU D 370. When the output from the voltage detection circuit 440 goes from H to L level, the voltage detection circuit issues an instruction to the optical sensor control circuit E 310 to increase the duty ratio when the optical sensor E 320 is driven intermittently, in order to compensate for decrease in the light emitted from the optical sensor E 320 and decrease in the light-receiving sensitivity caused by drop of the battery voltage; otherwise, misdetection would occur. As a result, with respect to decrease in the electric power associated with detection, if the battery voltage varies, better detection and control can be performed. Further power saving can be accomplished.

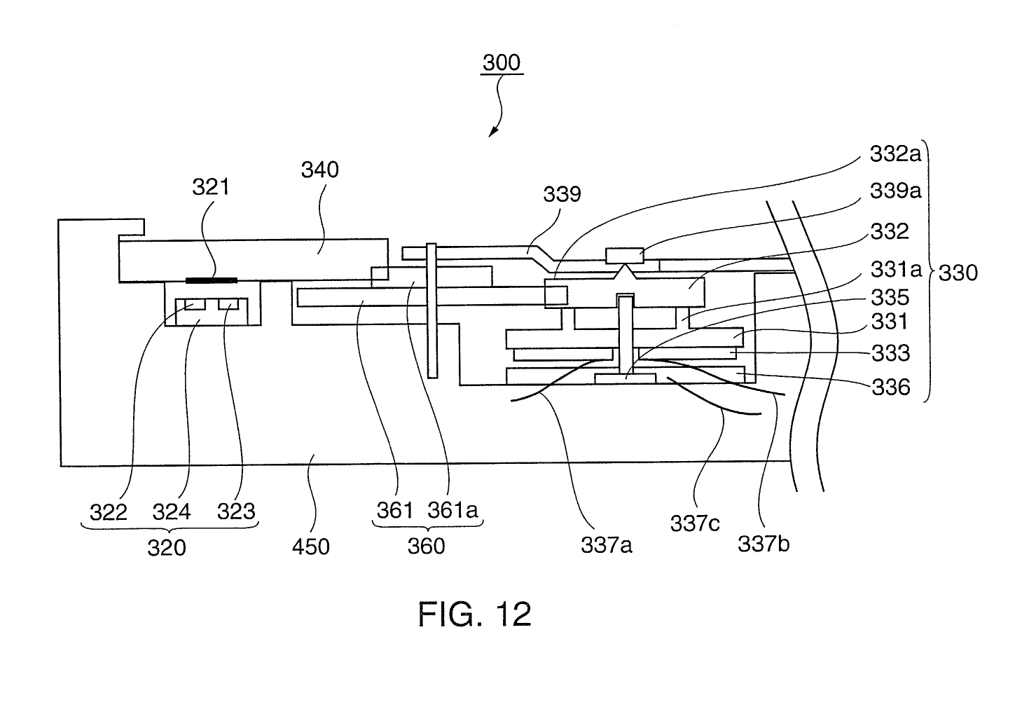

FIG. 12 is a view showing the structure of the calendar portion of the electronic apparatus 300. In this electronic apparatus 300, the calendar dial E 340 that is a driven member is driven by the ultrasonic motor 330 via the gear reducer E 360. The ultrasonic motor 330 comprises a disklike vibrator 331 made of an aluminum alloy, disklike piezoelectric elements 333 adhesively bonded to the underside of the vibrator 331 and used to excite vibration in the vibrator 331, a shaft 335 for supporting the center of the vibrator 331 so as not to suppress the vibration produced in the vibrator 331, a support plate 336 holding the shaft 335 and mounting the ultrasonic motor 330 to a base plate 450, a rotor 332 for obtaining a rotating force by the vibration produced in the vibrator 331, and a pressure application spring 339a for pressing the rotor 332 against the vibrator 331 at a given pressure. Six protrusions 331a are formed on the surface of the vibrator 331 to take the rotating force from the vibration to the rotor 332.

The rotor 332 is pressed against the protrusions 331a by the pressure application spring 339a. The force of the protrusions 331a caused by vibration of the vibrator 331 is frictionally transmitted to the rotor 332. As a result, the rotor 332 is rotated. Lead wires 337a and 337b from the surfaces of the piezoelectric elements 333 and lead wires 337c taken from the rear surfaces of the piezoelectric elements 333 via the vibrator 331, the shaft 335, and the support plate 336 are connected with the ultrasonic motor driver circuit 380. The rotor 332 is rotated while guided by the shaft 335 that supports the vibrator 331. A pivot mounted at the top of the rotor 332 accepts the pressure application spring 339a that is formed in a part of a receiving member 339. Teeth 332a are formed on the outer surface of the rotor 332.

Twelve electrodes that are circumferentially separated from each other are mounted on the surfaces of the piezoelectric elements 333 facing away from the surface bonded to the vibrator 331. Six alternate ones of these 12 electrodes form a set of electrodes, while the other alternate six electrodes form another set of electrodes. The lead wires 337a and 337b are connected with these two sets of electrodes, respectively. A full-size electrode is mounted on the whole surface of the piezoelectric device 333 bonded to the vibrator, and is electrically connected with the vibrator 331 of an aluminum alloy. Flexural standing waves having three waves circumferentially and one nodal circle are excited in the vibrator 331 of the ultrasonic motor 330. The protrusions 331a formed on the surface of the vibrator 331 are located midway between the antinode and the node of one wave of the flexural standing waves. These 6 protrusions are circumferentially equally spaced from each other on the surface of the vibrator 331. The direction of rotation of the ultrasonic motor 330 is switched by using either one of the two sets of electrodes described above.

The gear reducer 360 for transmitting the power of the ultrasonic motor 330 to the calendar dial E 340 comprises a gear 361 in mesh with the teeth 332a formed on the outer surface of the rotor 332 of the ultrasonic motor 330 and a pinion 361a mounted integrally with the gear 361. The pinion 361a is in mesh with teeth formed on the inner surface of the calendar dial E 340.

The calendar dial E 340 is guided and driven on the base plate 450. An optical sensor E 320 for detecting the rotational position of the calendar dial E 340 is installed in a groove formed in the base plate 450 on the side of the bottom surface. This optical sensor E 320 comprises an LED 322, a phototransistor 323, and a package 324. Thirty-one reflective plates 321 are circumferentially regularly spaced from each other on the surface of the calendar dial E 340 opposite to the optical sensor E 320.

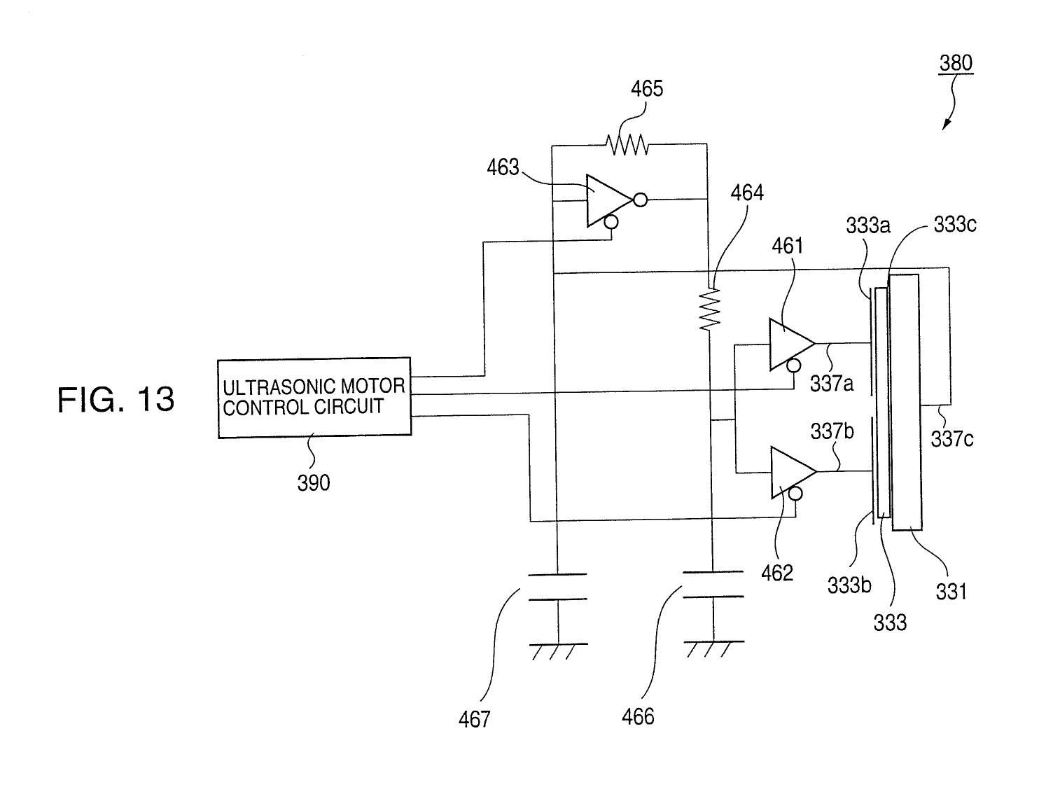

FIG. 13 is a circuit diagram of the ultrasonic motor driver circuit 380, which constitutes a self-excited oscillator circuit using the vibrator 331 to which the piezoelectric elements 333 are adhesively bonded, the piezoelectric elements 333 being a component of the ultrasonic motor 330. The vibrator 331 is self-excited and driven. As mentioned previously, two sets of electrodes 333a, 333b are mounted on the surfaces of the piezoelectric elements 333 on which the vibrator 331 is not bonded. Two buffers 461 and 462 for drive with which output terminals are connected are provided for these two sets of electrodes, respectively. The output signal from the full-size electrode 333c mounted on the surface of the piezoelectric device 333 bonded to the vibrator 331 is applied to an inverter 463 via the vibrator 331. The inverter 463 amplifies information about the vibration in the piezoelectric elements 333 and in the vibrator 331 and supplies it to the two buffers 461 and 462 via a limiting resistor 464. A feedback resistor 465 is connected in parallel with the input/output terminals of the inverter 463. This feedback resistor 465 maintains the operating point of the inverter 463 at half the voltage at the battery 430. A capacitor 466 has one end grounded, the other end being connected with the input terminals of the buffers 461, 462 and with the limiting resistor 464. The capacitor 466 cooperates with the limiting resistor 464 to form a filter circuit. Also, there is provided a capacitor 467 whose one end is grounded, the other end being connected with the input terminal of the inverter 463 and with the full-size electrode 333c (vibrator 331) of the piezoelectric elements 333. The amount of phase within the circuit is determined by the filter circuit and the capacitor 467, the filter circuit being formed by the capacitor 466 and the limiting resistor 464. Also, the oscillation point of self-oscillation is determined.

Each of the inverter 463 and the buffers 461, 462 has a control terminal in addition to input and output terminals, and is tristated so that an H or L signal applied to the control terminal enables or disables, respectively, the device. In particular, when a signal at L level is applied to the control terminal, the output terminal assumes a high-impedance state and no longer performs the function of an inverter or buffer (i.e., disabled). Conversely, when a signal at H level is applied to the control terminal, the inverter 463 acts as an inverting amplifier, and the buffers 461 and 462 serve as non-inverting amplifiers.

This ultrasonic motor 330 switches the direction of rotation by exciting the vibrator 331 using either one of the two sets of electrodes 333a, 333b mounted on the piezoelectric elements 333. Therefore, the direction of rotation varies according to which of the two buffers 461 and 462 is enabled. Specifically, the ultrasonic motor 330 is driven by self-excitation by enabling either one of the buffers 461 and 462 and the inverter 463. More specifically, if the ultrasonic motor control circuit 390 applies a signal at L level to the control terminals of all of the inverter 463 and buffers 461, 462, the ultrasonic motor 330 comes to a stop. If a signal at H level is applied to the inverter 463 and the buffer 461, and if a signal at L level is applied to the buffer 462, the motor is driven forward. Conversely, if a signal at H level is applied to the inverter 463 and the buffer 462, and if a signal at L level is applied to the buffer 462, the motor is driven backward.

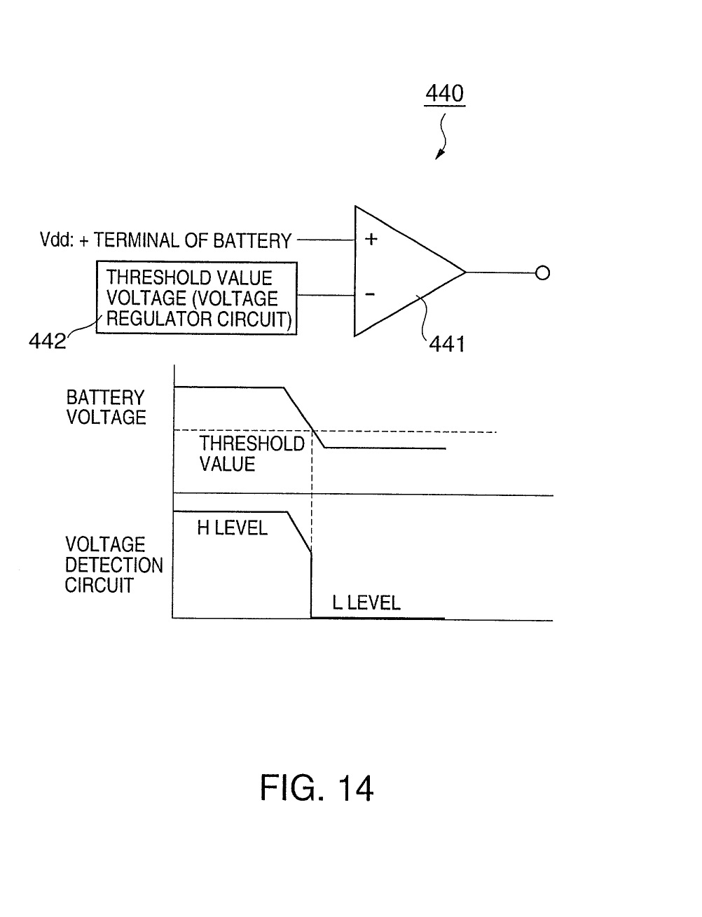

FIG. 14 is a diagram illustrating the voltage detection circuit 440, which consists of an operational amplifier acting as a comparator and a voltage regulating circuit that sets a threshold value for the detected voltage. If the voltage across the battery 430 is higher than the threshold value set by the voltage regulating circuit, the voltage detection circuit 440 produces an H-level signal to the CPU D 370. If the voltage is lower than the threshold value, the voltage detection circuit delivers an L-level signal to the CPU D 370.

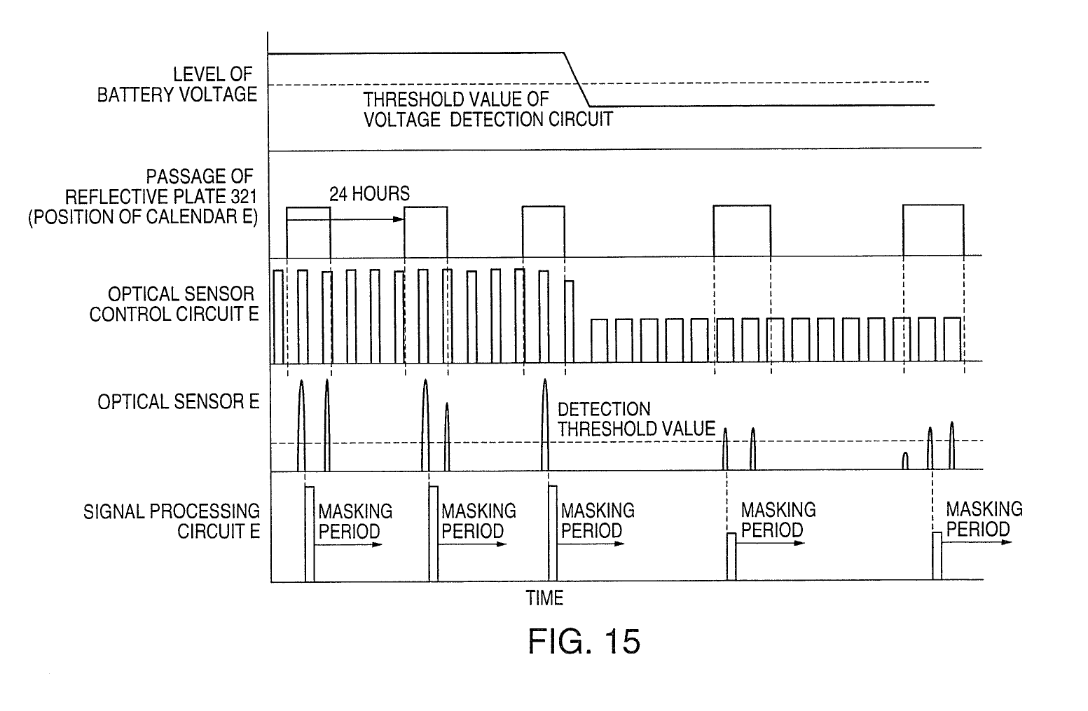

FIG. 15 is a diagram illustrating control signals in the electronic apparatus 300, especially illustrating control signals when the voltage of the battery 430 is varied due to battery capacity consumption. In the electronic apparatus 300, the calendar dial E 340 is driven a distance corresponding to one day, normally every 24 hours, i.e., whenever the time-indicating hand D 420 arrives at the zero o'clock position. Note that the calendar dial E is shown to rotate continuously to facilitate illustrating variations in the control signals in response to variations in the battery voltage in FIG. 15. In practice, the calendar dial E 340 can be driven continuously in accordance with an instruction from the CPU D 370.

The top graph indicates the level of the voltage of the battery 430. The graph shows that the voltage level of the battery 430 drops with discharging.

The reflective plate 321 mounted on the calendar dial E 340 passes across the position of the optical sensor E 320 located under the calendar dial E 340. This passage at the above-described voltage level is illustrated while plotting time on the horizontal axis. It can be seen from this graph that if the battery voltage drops below the threshold value for the power-supply detection circuit, it takes longer for the reflective plate 321 to pass across the position opposite to the optical sensor E 320. Also, the reflective plate 321 passes at longer intervals of time, for the following reason. As the battery voltage drops, the output from the ultrasonic motor 330 drops. Accordingly, the rotational speed of the calendar dial E decreases.

The CPU D 370 issues an instruction to the ultrasonic motor control circuit 390 to drive the ultrasonic motor 330 and, at the same time, gives an instruction to the optical sensor control circuit E 310 to drive the optical sensor E 320. In response to this, the optical sensor control circuit E 310 produces an output signal for intermittently driving the optical sensor E 320. To facilitate explaining the manner in which the control signal varies in response to variation of the battery voltage, the calendar dial E is shown to rotate continuously. If the voltage level of the battery 430 drops below a preset threshold value, the output from the voltage detection circuit 440 changes from H to L level. The output from the voltage detection circuit 440 is applied to the CPU D 370. If this CPU D 370 receives an L-level signal, the CPU gives an instruction to the optical sensor control circuit E 310 to increase the duty ratio of the intermittent drive of the optical sensor E. That is, the period of one emission of the intermittent drive of the LED 322 of the optical sensor E is prolonged. This is intended to prevent decreases in the emissive power of the optical sensor E 320 and in the light-receiving sensitivity due to drop of the battery voltage; otherwise, misdetection would occur.

If the optical sensor E 320 detects passage of the reflective plate 321, the sensor produces a detection pulse. If the battery voltage drops below the threshold value for the voltage detection circuit, the width of the detection pulse delivered from the phototransistor 323 relative to the emission time of the LED becomes much narrower and the light-receiving sensitivity drops greatly compared with the case where the threshold value for the voltage detection circuit is exceeded. Therefore, the threshold value can be exceeded by prolonging the emission time of the LED 322.

The signal processing circuit E 350 detects the falling edge of the first one of output pulses which are delivered from the optical sensor E 320 when passage of the reflective plate 321 is detected and which exceed the preset threshold value, and creates a pulse signal. After the creation of the pulse signal, a given masking period is established to prevent the signal processing circuit from producing plural pulses in response to one pass of the reflective plate 321.

In the present embodiment, a reflection type photo interrupter is used as the optical sensor E 320. The optical sensor may also be made of a transmissive type photo interrupter. Furthermore, a magnetic detection unit using a magnetoresistive device or Hall device may be used with equal utility.

As described thus far, the electronic apparatus 300 is equipped with the voltage detection circuit 440 and with the optical sensor control circuit E and thus decrease in the light emitted from the optical sensor E 320 and decrease in the light-receiving sensitivity due to drop of the battery voltage can be prevented; otherwise, misdetection would occur. As a result, with respect to decrease in the electric power associated with detection, if the battery voltage varies, better detection and control can be performed. Further power saving can be accomplished.

As described thus far, in the present invention, the detection unit is driven according to circumstances of operation of a driven member using the detection unit control circuit. Therefore, the detection unit can be driven optimally in terms of electric power without sacrificing the detection accuracy of the detection unit.

Furthermore, in the present invention, the state of drive of the detection unit can be varied. Therefore, the apparatus can cope with a corrective action owing to an external human operation which may greatly vary circumstances of drive of the driven member. Consequently, an electronic apparatus having more sophisticated functions can be accomplished while maintaining the reliability.

In addition, in the present invention, the manner in which the detection unit is driven can be varied via the detection unit control circuit according to information obtained from the voltage detection circuit. Therefore, if the electronic apparatus is urged to use a small-sized battery that tends to produce voltage level drop or great voltage level variations as a result of electric power consumption, the position detection accuracy possessed by the detection unit can be maintained while achieving power saving.

Moreover, in the present invention, the detection unit can be driven intermittently. Also, the drive frequency can be varied. Therefore, an electronic apparatus can be accomplished that produces the above-described effects of the invention and provides high accuracy and power saving if the driven member is operated over a wider range of circumstances.

Additionally, in the present invention, the detection unit can be driven intermittently. Also, the duty ratio in the intermittent drive can be varied. Therefore, the aforementioned effects of the present invention can be produced. In addition, the accuracy possessed by the detection unit can be maintained while achieving power saving if the circumstances under which the detection unit is driven vary such as power-supply level variations.

Further, in the present invention, it is easy to vary the state of drive of the detection unit using the detection unit control circuit owing to the usage of the optical sensor. The above-described effects of the present invention are intensified further.

Further, the present invention permits realization of an electronic apparatus which displays plural kinds of information, achieves power saving, and has high positional accuracy.

Further, in the present invention, the piezoelectric actuator produces a large force and can feed a driven member in small increments. Therefore, the position of the driven member can be detected accurately in spite of power saving. Hence, the positioning resolution can be enhanced.

Further, the present invention makes it easy to fabricate a rotary piezoelectric actuator, i.e., a piezoelectric motor. This can be easily combined with a detection unit. As a result, the electric power necessary for position detection can be saved well.

What is claimed is:

1. An electronic apparatus comprising:
a power source for driving the electronic apparatus;
a driven member driven by the power source;
a detection unit for detecting the position of the driven member; and
a detection unit control circuit for varying the state of drive of the detection unit according to circumstances of operation of the driven member.

2. The electronic apparatus of claim 1, further including an external corrective unit for correcting the position of the driven member in response to an external operation and an external operation detection unit for detecting the state of operation of the external corrective unit, and wherein the detection unit control circuit recognizes circumstances of operation of the driven member according to information obtained from the external operation detection unit and varies the state of drive of the detection unit.

3. The electronic apparatus of claim 1, further including a voltage detection circuit for detecting voltage level of a power supply, and wherein the detection unit control circuit recognizes circumstances of operation of the driven member based on information obtained from the voltage detection circuit and varies the state of drive of the detection unit.

4. The electronic apparatus of claim 1, wherein the detection unit control circuit intermittently drives the detection unit and varies drive frequency of intermittent drive according to circumstances of operation of the driven member.

5. The electronic apparatus of claim 1, wherein the detection unit control circuit intermittently drives the detection unit and varies the duty ratio of intermittent drive according to circumstances of operation of the driven member.

6. The electronic apparatus of claim 1, wherein the detection unit is an optical sensor comprising a light-emitting device and a light-receiving device.

7. The electronic apparatus of claim 1, wherein
the power source has a first power source for displaying information about time and a second power source for displaying information different from the information about time,
the driven member has a first driven member driven by the first power source and a second driven member driven by the second power source, and
the display member has a first display member driven by the first driven member and a second display member driven by the second driven member.

8. The electronic apparatus according to claim 1, wherein at least one of the power sources is fabricated using a piezoelectric ceramic.

9. The electronic apparatus of claim 8, wherein the piezoelectric actuator comprises a piezoelectric vibrator having the piezoelectric ceramic, a moving body for obtaining a driving force by vibrational waves generated by the piezoelectric vibrator, and a pressure application member for pressing the piezoelectric vibrator and the moving body into contact with each other.
